(19) United States
(12) Patent Application Publication
(10) Pub. No.: US 2015/0358231 A1
(43) Pub. Date: Dec. 10, 2015

(54) VEPA SWITCH MESSAGE FORWARDING

(71) Applicant: HANGZHOU H3C TECHNOLOGIES CO., LTD., Hangzhou, Zhejiang (CN)

(72) Inventors: Lianlei ZHANG, Beijing (CN); Tao LIN, Beijing (CN); Weichun REN, Beijing (CN); Yang LIU, Beijing (CN); Shaobo WU, Beijing (CN)

(21) Appl. No.: 14/758,701

(22) PCT Filed: Aug. 30, 2013
(86) PCT No.: PCT/CN2013/082618

§ 371 Date: Jun. 30, 2015

(30) Foreign Application Priority Data
Feb. 28, 2013 (CN) 201310062995.X

(51) Int. Cl. H04L 12/721; H04L 12/937; H04L 12/741; H04L 12/931

(52) U.S. Cl. CPC H04L 45/38; H04L 49/70; H04L 49/254; H04L 45/745

(57) ABSTRACT

According to an example, a VEPA switch may receive a message and a determination may be made as to whether a Datapath of the VEPA switch includes a flow table entry for forwarding the message. In response to a determination that the VEPA switch does not include a flow table entry for forwarding the message, the message may be forwarded to a SDN controller through a SDN protocol that is to construct the flow table entry for forwarding the message according to information contained in the message, in which the constructed flow table entry identifies an egress port of the VEPA switch for forwarding the message. The VEPA switch may also obtain the constructed flow table entry from the SDN controller and forward the message via the egress port identified in the obtained flow table entry.

### BACKGROUND

A virtual switch supporting the conventional Edge Virtual Bridging (EVB) technique typically includes a Virtual Edge Bridge (VEB) and a Virtual Edge Port Aggregator (VEPA) switch. The VEB may generally be defined as software that acts similarly to a Layer 2 hardware switch and provides inbound/outbound and inter-Virtual Machine (VM) communication. The VEPA switch in the conventional EVB technique hands all of the network traffic generated by a VM to a Top of Rack (ToR) switch, which may also be called an edge switch. The ToR switch not only processes traffic addressed to destinations outside of the server in which a VM is located, but also processes traffic among the VMs on the same server. The ToR switch processes the traffic both originating from and among the VMs by looking up a table and forwarding the traffic to the destination VM. The VEPA switch not only forwards traffic among VMs through the ToR switch, but also supervises the traffic communicated from and to the VMs. In addition, the VEPA switch incorporates a VM access layer network into a conventional server access network management system and performs message forwarding based on the MAC addresses of the packets contained in the traffic.

### BRIEF DESCRIPTION OF THE DRAWINGS

Features of the present disclosure are illustrated by way of example and not limited in the following figure(s), in which like numerals indicate like elements, in which:

FIG. 1 is a simplified diagram of a device and a SDN controller, according to an example of the present disclosure;

FIG. 2 is a simplified block diagram of the VEPA switch depicted in FIG. 1, according to an example of the present disclosure;

FIG. 3 is a flow diagram of a method for forwarding a message by a VEPA switch, according to an example of the present disclosure;

FIG. 4 is a flow diagram of a method for managing message forwarding by a SDN controller, according to an example of the present disclosure;

FIGS. 5-8, respectively, depict examples in which messages are communicated through the VEPA switch depicted in FIG. 1, according to examples of the present disclosure;

FIG. 9 illustrates a schematic representation of a computing device, which may be employed to perform various functions of the device depicted in FIG. 1, according to an example of the present disclosure; and

FIG. 10 illustrates a schematic representation of a computing device, which may be employed to perform various functions of the SDN controller depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are methods and apparatuses for managing message forwarding and for forwarding a message. According to an example, a Virtual Edge Port Aggregator (VEPA) switch may receive a message and may determine whether a path forwarding database (Datapath) of a data forwarding plane in the VEPA switch includes a flow table entry or entries for forwarding the message. In response to a determination that the VEPA switch does not include a flow table entry or entries for forwarding the message, the VEPA switch may forward the message to a software defined networking (SDN) controller through a SDN protocol. In response to receiving the message from the VEPA switch, the SDN controller may construct a flow table entry or entries for forwarding the message according to information contained in the message, in which the flow table entry or entries identify an egress port of the VEPA switch for forwarding the message. In addition, the SDN controller may forward the constructed flow table entry or entries to the VEPA switch and the VEPA switch may forward the message through the egress port identified in the flow table entry or entries.

Through implementation of the methods and apparatuses disclosed herein, when a VEPA switch determines that the Datapath of the VEPA switch does not include a flow table entry for forwarding a message, the VEPA switch may receive a flow table entry or entries for forwarding the message from a SDN controller. According to an example, the SDN controller supports the OpenFlow protocol and is connected to the VEPA switch through the OpenFlow protocol. As discussed in greater detail herein, through interaction with the SDN controller, the VEPA switch may obtain flow table entries for forwarding messages in a relatively simple and flexible manner. In contrast, conventional VEPA switches typically perform message forwarding based on MAC addresses, which generally restricts the flexibilities of the conventional VEPA switches.

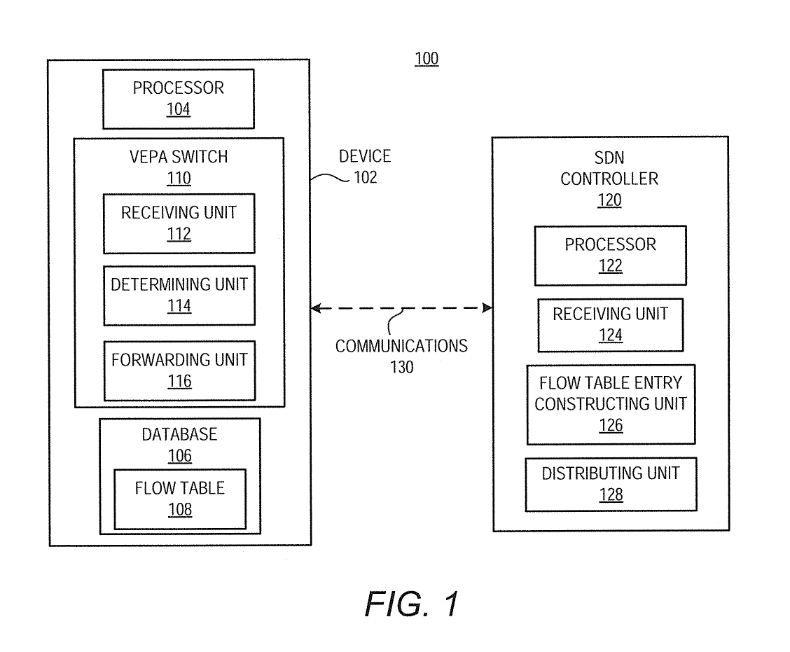

With reference to FIG. 1, there is shown a simplified diagram 100 of a device 102 and a SDN controller 120, according to an example. It should be understood that the diagram 100 may include additional elements and that some of the elements depicted therein may be removed and/or modified without departing from a scope of the diagram 100.

FIG. 1 depicts a device 102, a SDN controller 120, and communications 130 that may occur between the device 102 and the SDN controller 120. The device 102 and the SDN controller 120 may be servers or other computing devices that are to communicate to each other over a wired or wireless connection. The device 102 is depicted as including a processor 104, a database 106 having a flow table 108, and a VEPA switch 110 that may communicate with the SDN controller 120 over a secure channel. The VEPA switch 110 is also depicted as including a receiving unit 112, a determining unit 114, and a forwarding unit 116. In addition, the SDN controller 120 is depicted as including a processor 122, a receiving unit 124, a flow table entry constructing unit 126, and a distributing unit 128. It should be clearly understood that the device 102 and the SDN controller 120 may include various other components without departing from the scopes of the device 102 and the SDN controller 120.

The processors 104 and 122 may each be a microprocessor, a micro-controller, an application specific integrated circuit (ASIC), and the like, are to perform various processing functions. The processor 104 of the device 102 may perform processing functions that include implementing the VEPA switch 110 as discussed in greater detail below. The processor 122 in the SDN controller 120 may include implementing the receiving unit 124, the flow table entry constructing unit 126, and the distributing unit 128, as also discussed in greater detail below.

According to an example, the receiving unit 112, the determining unit 114, and the forwarding unit 116 may be machine readable instructions stored on a non-transitory computer readable storage medium. Likewise, the receiving unit 124, the flow table entry constructing unit 126, and the distributing unit 128 may be machine readable instructions stored on a non-transitory computer readable storage medium. In another example, the receiving unit 112, the determining unit 114, the forwarding unit 116, the receiving unit 124, the flow table entry constructing unit 126, and the distributing unit 128 be hardware components, e.g., individual or combined circuits. In a yet further example, the receiving unit 112, the determining unit 114, the forwarding unit 116, the receiving unit 124, the flow table entry constructing unit 126, and the distributing unit 128 may be a combination of machine readable instructions and hardware components.

Although not shown, the device 102 may include a data store on which the database 106 is stored. The processor 104 may also store additional data in the data store, such as messages received by the device 102 that are to be forwarded on a network. According to an example, the VEPA switch 110 may be stored on the data store. The data store may be volatile and/or non-volatile memory, such as DRAM, EEPROM, MRAM, phase change RAM (PCRAM), memristor, flash memory, and the like. In addition, or alternatively, the data store may be a device that may read from and write to a removable media, such as, a floppy disk, a CD-ROM, a DVD-ROM, or other optical or magnetic media.

According to an example, the VEPA switch 110 is a switch virtualized from the device 102. For instance, the VEPA switch 110 may be virtualized through a use of a commercially available product, such as the vNetwork Distributed Switch available from VMware®. The VEPA switch 110 may also support the Openflow protocol, and may thus be called an Openflow switch.

As noted above, according to an example, the SDN controller 120 may also support the OpenFlow protocol and the communications 130 between the VEPA switch 110 and the SDN controller 120 may be based upon the OpenFlow protocol. Generally speaking, the OpenFlow protocol enables conventional layer 2 and layer 3 switches to have a fine-granularity flow forwarding capability, i.e., a conventional MAC-based network packet forwarding, in which the IP-based route forwarding is expanded into flow forwarding based on a description contained in a header of a multi-domain network packet. In addition, under the OpenFlow protocol, a control layer, which is typically contained in a forwarding device, e.g., switch, is stripped from the forwarding device and the decisions regarding all of the forwarding actions are migrated to an OpenFlow controller. In one regard, the SDN controller 120 may operate as an OpenFlow controller.

The VEPA switch 110 may implement the flow table 108 contained in the database 106 for message searching and forwarding. Particularly, for instance, the receiving unit 112 may receive a message from a virtual machine in a domain of the VEPA switch 110 or from an external host (not shown). In addition, the determining unit 114 may search the flow table entries in the flow table 108 to determine an egress port or ports for forwarding the received message. According to an example, each of the flow table entries at least includes header fields, counters, and zero or several actions. By way of particular example, the header fields include 12 fields as shown in Table 1 below. The 12 fields include ingress port, Ethernet source address (Ether Source), Ethernet destination address (Ether Dst), Ethernet type (Ether Type), virtual local area network identifier (VLAN ID), VLAN priority, internet protocol (IP) source address (IP src), IP destination address (IP dst), IP protocol (IP proto), IP type of service (ToS) bits, transmission control protocol/user datagram protocol (TCP/UDP) source port (TCP/UDP Src port), and TCP/UDP destination port (TCP/UDP Dst Port). Each field may include a determined value. In addition, a mask code may be implemented to improve accuracy of the matching of received messages to the flow table entries.

TABLE 1

| | | | | | | | | | | | |
|---|---|---|---|---|---|---|---|---|---|---|---|
| Ingress | Ether | Ether | Ether | Vlan | Vlan | IP | IP | IP | IP | TCP/UDP | TCP/ |
| Port | Source | Dst | Type | id | Priority | src | dst | proto | ToS | Src Port | UDP |
| | | | | | | | | | bits | | Dst |
| | | | | | | | | | | | Port |

Each table entry in the flow table 108 may correspond to zero or to at least one action. In addition, if there is no forwarding action listed in a table entry, the default may be to discard that table entry. According to an example in which the flow table entries include multiple actions, the multiple actions may be performed sequentially according to the priorities of the multiple actions. In addition, there may be no sequence for the transmission of packets. Moreover, an error may be returned for an unsupported action, e.g., an unsupported flow error.

In the event that the determining unit 114 determines that the flow table 108 does not include flow table entries for forwarding the received message, the forwarding unit 116 may forward the message to the SDN controller 120. Particularly, the forwarding unit 116 may forward the message through a secure channel. In addition, the SDN controller 120 may communicate with the device 120 through a secure channel. According to an example, the communications 130 may be performed under the OpenFlow protocol and may implement security features of the OpenFlow protocol. In any regard, the receiving unit 124 of the SDN controller 120 may receive the message from the VEPA switch 110. In addition, the flow table entry constructing unit 126 may construct a flow table entry or entries for forwarding the message based upon information contained in the message, in which the flow table entry or entries identifies at least one egress port of the VEPA switch 110. Moreover, the distributing unit 128 may communicate the constructed flow table entry or entries to the VEPA switch 110. In response to receipt of the flow table entry or entries, the VEPA switch 110 may forward the message through the egress port or ports identified in the flow table entry or entries received from the SDN controller 110.

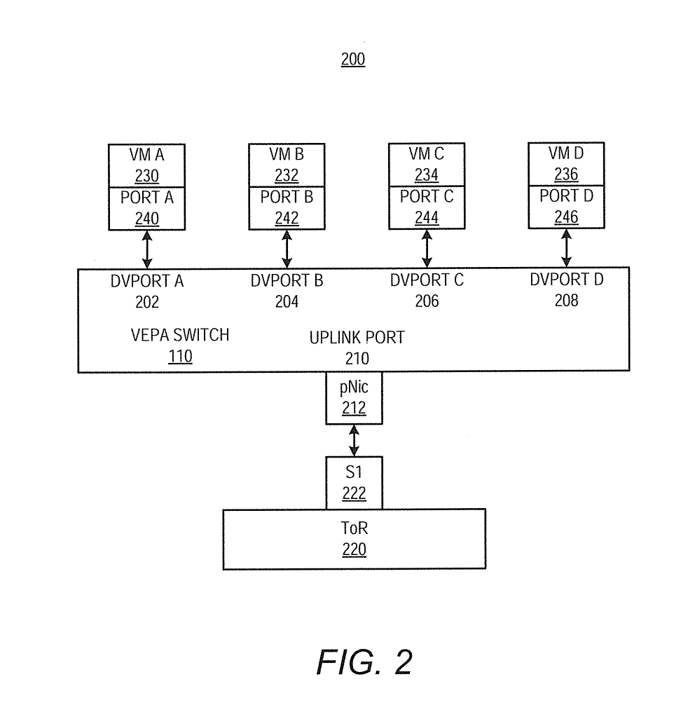

Turning now to FIG. 2, there is shown a simplified block diagram 200 of the VEPA switch 110, according to an example. It should be understood that the VEPA switch 110 depicted in FIG. 2 may include additional elements and that some of the elements depicted therein may be removed and/or modified without departing from a scope of the VEPA switch 110 depicted in FIG. 2.

As shown in FIG. 2, the VEPA switch 110 may support two types of interfaces. One type of interface is a downlink interface, which may be called a dvport. Another type of interface is an uplink interface, which may be called an uplink port. Downlink interfaces (dvports) may be interfaces that are for connection VMs that are internal to the device 102 hosting the VEPA switch 110 and an uplink interface (uplink port) may be an interface in the device hosting the VEPA switch 110 that is for connection to an external physical device, for instance, an edge device. The VEPA switch 110 is depicted as having four dvports A-D 202, 204, 206, and 208 and one uplink port 210, although the VEPA switch 110 may include any number of dvports and uplink ports. The uplink port 210 may be connected to a Top of Rack (ToR) 220 or other physical network switch, such as an edge switch, through a peripheral component interconnect (pNic) 212 and a physical port (S1) 222. In addition, the dvports 202, 204, 206, and 208 may be connected to respective virtual machines (VMs) A-D 230, 232, 234, and 236 through respective virtual network interface controller interface ports A-D 240, 242, 244, and 246 of the VMs 230, 232, 234, and 236.

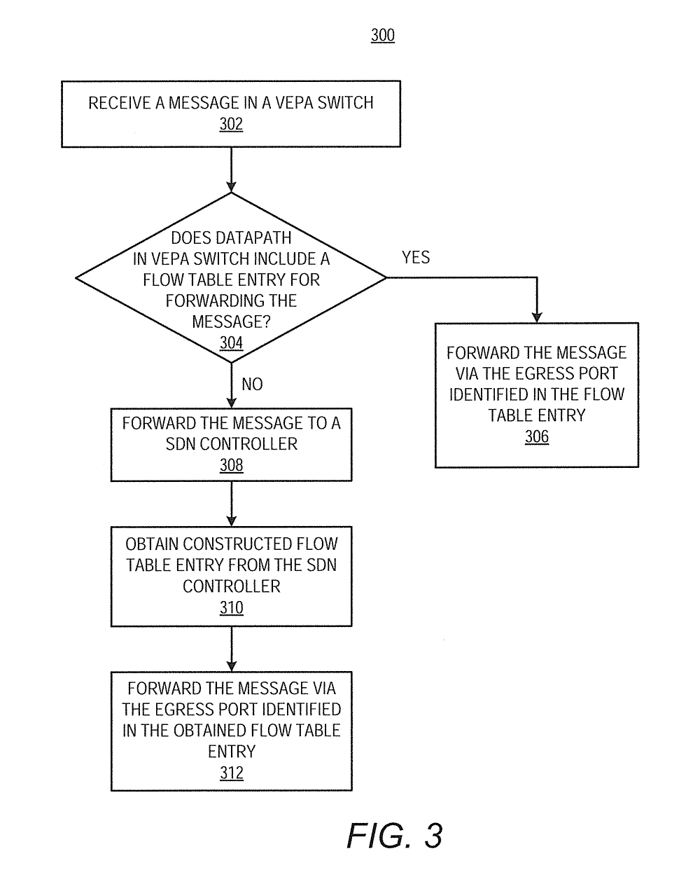

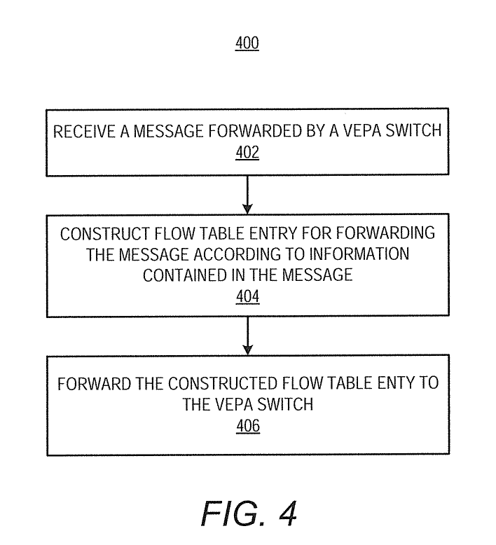

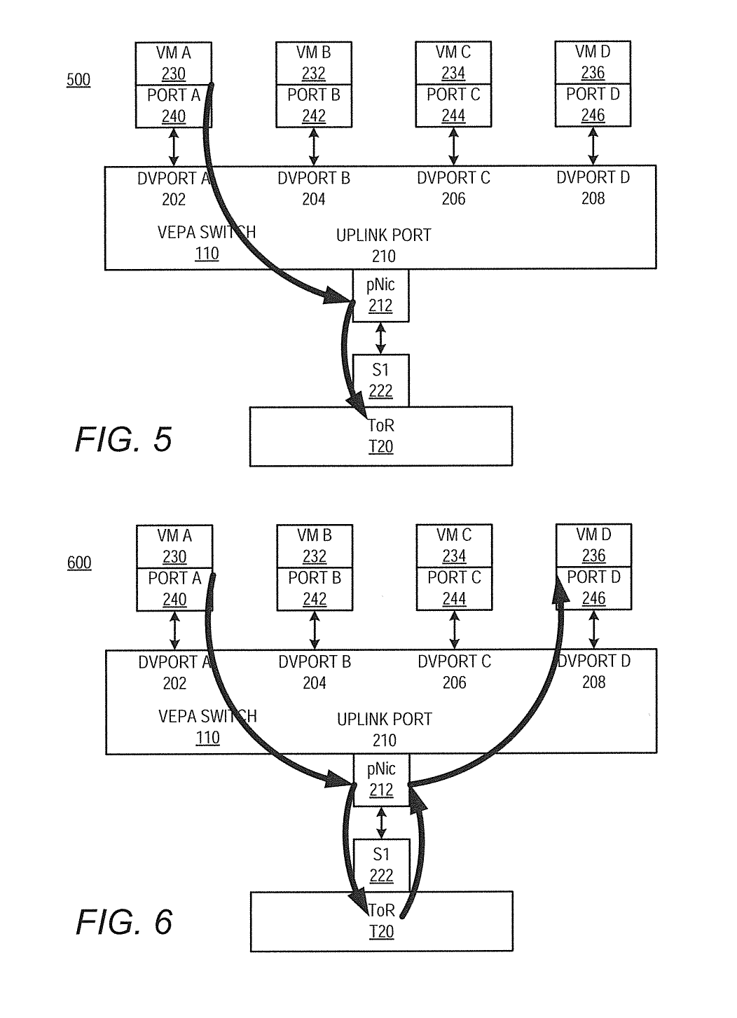

Various manners in which the VEPA switch 110 and the SDN controller 120 may operate are discussed in greater detail with respect to the methods 300 and 400 respectively depicted in FIGS. 4 and 5. Particularly, FIG. 3 depicts a flow diagram of a method 300 for forwarding a message by a VEPA switch 110 and FIG. 4 depicts a flow diagram of a method 400 for managing message forwarding by a SDN controller 120, according to two examples. It should be apparent to those of ordinary skill in the art that the methods 300 and 400 represent generalized illustrations and that other operations may be added or existing operations may be removed, modified or rearranged without departing from the scopes of the methods 300 and 400.

With reference first to FIG. 3, at block 302, the VEPA switch 110, and particularly, the receiving unit 112, may receive a message. In one example, the VEPA switch 110 may receive the message from any of the VMs 230, 232, 234, 236 through a dvport 202, 204, 206, 208. Messages received through a dvport 202, 204, 206, 208 may be called uplink messages. In another example, the VEPA switch 110 may receive the message from the ToR 220 through an uplink port 210. Messages received through an uplink port 210 may be called downlink messages.

At block 304, the VEPA switch 110, and particularly, the determining unit 114, may determine whether a path forwarding database (Datapath) of the VEPA switch 110 includes a flow table entry for forwarding the message. That is, the VEPA switch 110 may determine whether the flow table 108 in the database 106 includes a flow table entry or entries for forwarding the message that identifies the egress port or ports through which the message is to be forwarded by the VEPA switch 110. As discussed above, the VEPA switch 110 may implement a mask on the flow table entries to determine whether the database 106 includes a flow table entry or entries for forwarding the message. The flow table entries and various manners in which the VEPA switch 110 may determine whether the flow table 108 includes a flow table entry or entries for forwarding the message are described herein. According to an example, the Datapath is in the data forwarding plane of the VEPA switch 110.

In response to a determination that the Datapath includes a flow table entry for forwarding the message, the VEPA switch 110 may forward the message via an egress port identified in the flow table entry for that message, as indicated at block 306.

However, in response to a determination that the Datapath does not include a flow table entry for forwarding the message, the VEPA switch 110, and particularly, the forwarding unit 116, may forward the message to a SDN controller 120, as indicated at block 308. As discussed above, the SDN controller 120 may be an Openflow controller and the VEPA switch 110 may forward the message through the Openflow protocol. By way of example, packet-in messages specified by the Openflow protocol may be used to forward the message to the SDN controller 120.

As discussed in greater detail herein below with respect to FIG. 3, the SDN controller 120 may construct a flow table entry or entries for forwarding the message by the VEPA switch 110 according to information contained in the message. In addition, the SDN controller 120 may construct the flow table entry or entries to identify an egress port or ports of the VEPA switch 110 for forwarding the message. The SDN controller 120 may further forward the constructed flow table entry or entries to the VEPA switch 110.

At block 310, the VEPA switch 110, and particularly, the receiving unit 112, may obtain the constructed flow table entry or entries from the SDN controller 120. In addition, the VEPA switch 110, and particularly, the forwarding unit 116, may forward the message via the egress port or ports identified in the obtained flow table entry or entries.

Turning now to FIG. 4, the method 400 may be performed following receipt of the message from the VEPA switch 110 at block 308 in FIG. 3. At block 402, the SDN controller 120, and particularly, the receiving unit 124, may receive the message from the VEPA switch 110. As discussed above, the SDN controller 120 may implement Openflow and thus, the SDN controller 120 may receive the message from the VEPA switch 110 through use of the Openflow protocol.

At block 404, the SDN controller 120, and particularly, the flow table entry constructing unit 126, may construct a flow table entry or entries for forwarding the message according to information contained in the message. The flow table entry or entries may identify an egress port of the VEPA switch 110 through which the message is to be forwarded.

At block 406, the SDN controller 120, and more particularly, the distributing unit 128, may forward the constructed flow table entry to the VEPA switch 110. According to an example, the SDN controller 120 may distribute the constructed flow table entry to the Datapath of the VEPA switch 110 through a flow table message, such as OFFlowMod.OFPFC_ADD.

According to an example, the SDN controller 120 may store information pertaining to all of the dvports 202, 204, 206, and 208 and the uplink port 210 of the VEPA switch 110, such as the port names, port MAC addresses, etc. The SDN controller 120 may also store information pertaining to the network interface controllers (ports 240, 242, 244, and 246) of the virtual machines 230, 232, 234, and 236 and the dvports 202, 204, 206, and 208 to which the network interface controllers are connected. According to a particular example, the virtual machines 230, 232, 234, and 236 are in the same broadcast domain.

The SDN controller 120 may construct the flow table entry or entries for forwarding the message according to information contained in the message and based upon the stored information of the ports, such as the port name, port MAC address, etc. Particularly, for instance, the SDN controller 120 may analyze the source port, the source MAC address, and the destination MAC address carried in the message to construct the flow table entry or entries for forwarding the message. In one regard, the constructed flow table entry may include header fields that facilitate the matching of messages with the flow table entries and actions that include the egress ports for forwarding the messages by the VEPA switch 110.

The SDN controller 120 may construct the flow table entry or entries to identify the egress port or ports for forwarding the message by the VEPA switch 110 in any of a variety of manners as discussed below.

Various manners in which the VEPA switch 110 may determine whether the VEPA switch 110 contains a Datapath that includes flow table entries for forwarding the message and the SDN controller 120 may construct the flow table entry or entries are discussed in greater detail below with respect to the following examples.

In a first example in which the message forwarded by the VEPA switch 110 to the SDN controller 120 has the following characteristics: the source MAC address and the destination MAC address are MAC addresses of two different virtual machines (VMs) connected to the VEPA switch 110 and the VEPA switch 110 received the message through a dvport port 202, 204, 206, or 208. In this example, the SDN controller 120 may construct the flow table entry for forwarding the message as shown in Table 2 below.

TABLE 2

| Header Field | | Counter | Actions |
|---|---|---|---|
| IngressPort | EtherSource | N1 | OutPort |
| Source port | Source MAC | | Uplink |
| carried in the | address of the | | |
| message | message | | |

In Table 2, the counter is used to maintain the flow table entries so as to update the flow table entries in time. In an example in which the VM A 230 (whose MAC address is MAC A) shown in FIG. 2 sends messages (e.g., unicast messages, multicast messages, or broadcast messages) through a virtual network interface controller port A 240, and the VEPA switch 110 receives the messages through dvport A 202, Table 2 may be as shown in Table 3 below.

TABLE 3

| Header Field | | Counter | Actions |
|---|---|---|---|
| IngressPort | EtherSource | N1 | OutPort |
| Port A | MAC A | | uplink |

Based upon the flow table entries in this example, the VEPA switch 110 may determine whether a Datapath of a data forwarding plane includes flow table entries for forwarding the message at block 304 by searching the Datapath of the data forwarding plane for flow table entries meeting the following requirement: header fields including the source MAC address and source port of said message. If such flow table entries are found, the VEPA switch 110 may determine that the Datapath of the data forwarding plane includes flow table entries for forwarding the message. However, if such flow table entries are not found, the VEPA switch may determine that the Datapath of the data forwarding plane does not include flow table entries for forwarding said message.

An example in which the VEPA switch 110 receives a message from VM A 230 and forwarded to the ToR 220 at either of blocks 306 and 312 in FIG. 3 is depicted in the diagram 500 in FIG. 5.

In a second example in which the message forwarded by the VEPA switch 110 to the SDN controller 120 has the following characteristics: the message is a unicast message, the destination MAC address is the MAC address of the VM connected to the VEPA switch 120, and the VEPA switch 110 received the message via the uplink port 210. In this example, the SDN controller 120 may construct the flow table entry for forwarding the message by the VEPA switch 110 as shown in Table 4 below.

TABLE 4

| Header Field | | Counter | Actions |
|---|---|---|---|
| Message | EtherDst | N2 | Output |
| receiving port | | | |
| Uplink port | Destination | | Dvport of the VEPA |
| | MAC | | switch that is |
| | address of | | connected to the VM |
| | the | | having the destination |
| | message | | MAC address of the |
| | | | message |

In an example in which the unicast message sent by the VM A 230 to VM D 236 shown in FIG. 2 is reflected back to the uplink port 210 of the VEPA switch 110 via a ToR 220, Table 4 may be as shown in Table 5:

TABLE 5

| | | |
|---|---|---|
| Header Field | Counter | Actions |

| | | |
|---|---|---|
| Message receiving port | EtherDst | OutPort |
| uplink port | MAC D | dvport port D |

Based on the flow table entries in this second example, the VEPA switch 110 may determine whether a Datapath of a data forwarding plane includes a flow table entry for forwarding the message at block 304 by searching the Datapath of the data forwarding plane for a flow table entry or entries including the uplink port receiving the message and the destination MAC address of the message. If such a flow table entry is found, the VEPA switch 110 may determine that the Datapath of the data forwarding plane includes a flow table entry or entries for forwarding the message. If such a flow table entry is not found, the VEPA switch 110 may determine that the Datapath of the data forwarding plane does not include a flow table entry or entries for forwarding the message.

An example in which the VEPA switch 110 receives a message from VM A 230, forwards the message to the ToR 220, receives a constructed flow table entry from the ToR 220, and forwards the message to VM D 236 at block 312 in FIG. 3 is depicted in the diagram 600 in FIG. 6.

In a third example in which the message forwarded by the VEPA switch 110 to the SDN controller 120 has the following characteristics: the message is a multicast message, such as a broadcast message or a multicast message, the source MAC address is the MAC address of a VM connected to the VEPA switch 110, and the VEPA switch 110 is received via the uplink port. In this example, the SDN controller 120 may construct the flow table entry for forwarding the message by the VEPA switch 110 as shown in Table 6 below.

TABLE 6

| Header Field | | | Counter | Actions |
|---|---|---|---|---|
| Message | EtherSource | EtherDst | N3 | OutPort |
| receiving | | | | |
| port | | | | |
| uplink port | Source | ff:ff:ff:ff:ff:ff | | dvport ports of the |
| | MAC | | | VEPA switch |
| | address of | | | other than the one |
| | the | | | connected to the |
| | message | | | VM having the |
| | | | | source MAC |
| | | | | address of the |
| | | | | message |

In an example in which a multicast message sent by the VM A 230 to VM D 236 shown in FIG. 2 is reflected back to the uplink port 210 of the VEPA switch 110 via a ToR 220, Table 6 may be as shown in Table 7:

TABLE 7

| Header Field | | | Counter | Actions |
|---|---|---|---|---|
| Message | EtherSource | EtherDst | N3 | OutPort |
| receiving | | | | |
| port | | | | |
| Uplink port | MAC A | ff:ff:ff:ff:ff:ff | | All of the dvport |
| | | | | ports on the VEPA |
| | | | | switch other than |
| | | | | the dvport that is |
| | | | | connected to VM |
| | | | | A, i.e., dvports B, |
| | | | | C, D |

Based on the flow table entries in this third example, the VEPA switch 110 may determine whether a Datapath of a data forwarding plane includes flow table entries for forwarding the message at block 304 by searching the Datapath of the data forwarding plane for flow table entries including the uplink port 210 receiving the message and the source MAC address and destination MAC address of the message. If such flow table entries are found, the VEPA switch 110 may determine that the Datapath of the data forwarding plane includes flow table entries for forwarding the message. If such flow table entries are not found, the VEPA switch 110 may determine that the Datapath of the data forwarding plane does not include flow table entries for forwarding the message.

An example in which the VEPA switch 110 receives a multicast message from VM A 230, forwards the message to the ToR 220, receives constructed flow table entries from the ToR 220, and forwards the message to VM B-VM D 232, 234, and 236 at block 312 in FIG. 3 is depicted in the diagram 700 in FIG. 7.

In a fourth example in which the message forwarded by the VEPA switch 110 to the SDN controller 120 has the following characteristics: the message is a multicast message, such as a broadcast message or a multicast message, the source MAC address is not the MAC address of a VM connected to the VEPA switch 110, but the MAC address of an external host, and the message is received by the VEPA switch 110 via the uplink port 210. In this example, the SDN controller 120 may construct the flow table entries for forwarding the message by the VEPA switch 110 as shown in Table 8 below.

TABLE 8

| Header Field | | | Counter | Actions |
|---|---|---|---|---|
| Message | EtherSource | EtherDst | | OutPort |
| receiving | | | | |
| port | | | | |
| uplink port | source MAC | ff:ff:ff:ff:ff:ff | | all dvports of the |
| | address of the | | | VEPA switch |
| | message | | | |

In an example in which the ToR 220 shown in FIG. 2 sends the message sent by the external host to the uplink port 210 of the VEPA switch 110, Table 8 may be as shown in Table 9:

TABLE 9

| Header Field | | | Counter | Actions |
|---|---|---|---|---|
| message | EtherSource | EtherDst | | OutPort |
| receiving port | | | | |
| uplink port 1 | source MAC | ff:ff:ff:ff:ff:ff | | dvport ports A, B, |
| | address of | | | C, D |
| | external host | | | |

Based on the flow table entries in this fourth example, the VEPA switch 110 may determine whether a Datapath of a data forwarding plane includes flow table entries for forwarding the message at block 304 by searching the Datapath of the data forwarding plane for flow table entries including the uplink port that received the message and the source MAC address and destination MAC address of the message. If such flow table entries are found, the VEPA switch 110 may determine that the Datapath of the data forwarding plane includes flow table entries for forwarding the message. However, if such flow table entries are not found, the VEPA switch 110 may determine that the Datapath of the data forwarding plane does not include flow table entries for forwarding the message.

An example in which the VEPA switch 110 receives a multicast message from the ToR 220, which has been sent by an external host, via the uplink port 210, and forwards the message to VM A-VM D 230, 232, 234, and 236 at block 312 in FIG. 3 is depicted in the diagram 800 in FIG. 8.

It should be clearly understood that the flow table entries in each of the above-mentioned examples are only provided as examples and should thus not be construed as limiting features of the present disclosure. Instead, the flow table entries disclosed herein may also be extended as needed or desired. For example, the flow table entries in the first example may be extended so that the header fields thereof include the destination MAC address, etc.

It should also be clearly understood that, according to an example, when the SDN controller receives the message forwarded by the VEPA switch 110, if the message is an external unknown unicast message that is received by the VEPA switch 110 via an uplink port 210 connected to the ToR 220 and whose source MAC address and destination MAC address are not the MAC address of the VM connected to the VEPA switch 110, the SDN controller 120 may not construct a flow table entry for forwarding the message. Instead, the message may be broadcast in the broadcast domain through a Packet-out message.

Some or all of the operations set forth in the methods 300 and 400 may be contained as utilities, programs, or subprograms, in any desired computer accessible medium. In addition, the methods 300 and 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

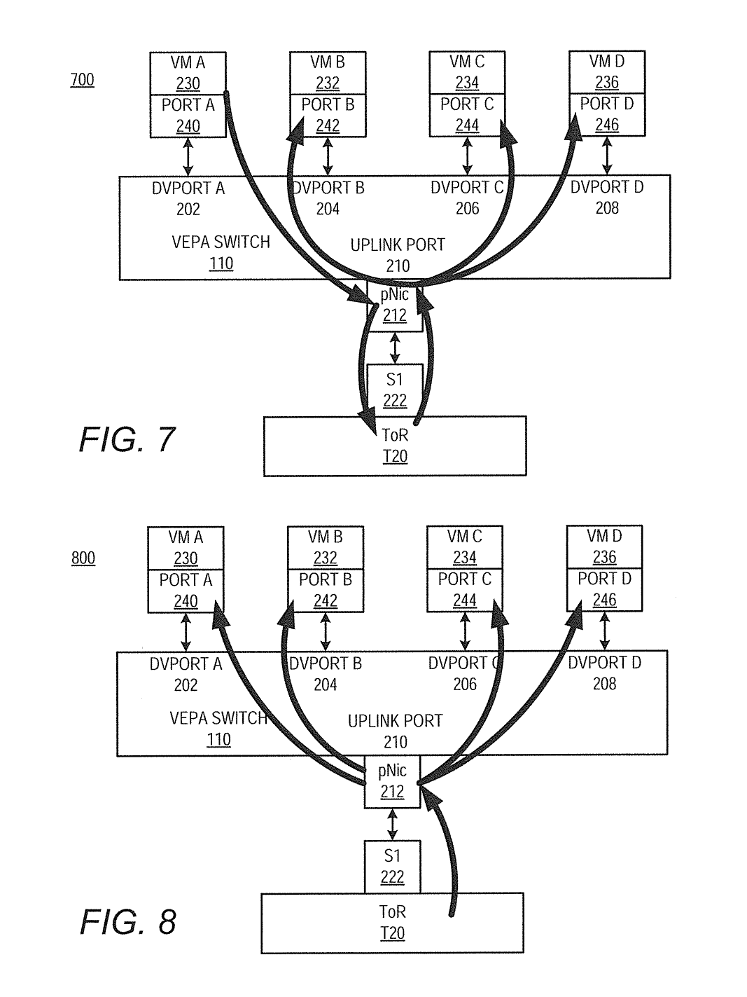

Turning now to FIG. 9, there is shown a schematic representation of a computing device 900, which may be employed to perform various functions of the device 102 depicted in FIG. 1, according to an example. The device 900 may include a processor 902, a display 904, such as a monitor; a network interface 908, such as a Local Area Network LAN, a wireless 802.11x LAN, a 3G mobile WAN or a WiMax WAN; and a computer-readable medium 910. Each of these components may be operatively coupled to a bus 912. For example, the bus 1012 may be an EISA, a PCI, a USB, a FireWire, a NuBus, or a PDS.

The computer readable medium 910 may be any suitable medium that participates in providing instructions to the processor 902 for execution. For example, the computer readable medium 910 may be non-volatile media, such as an optical or a magnetic disk; volatile media, such as memory. The computer-readable medium 910 may also store a VEPA switch application 914, which may perform the method 300 and may include the units 112-116 of the VEPA switch 110 depicted in FIG. 1. In this regard, the VEPA switch application 914 may include a receiving unit 112, a determining unit 114, and a forwarding unit 116.

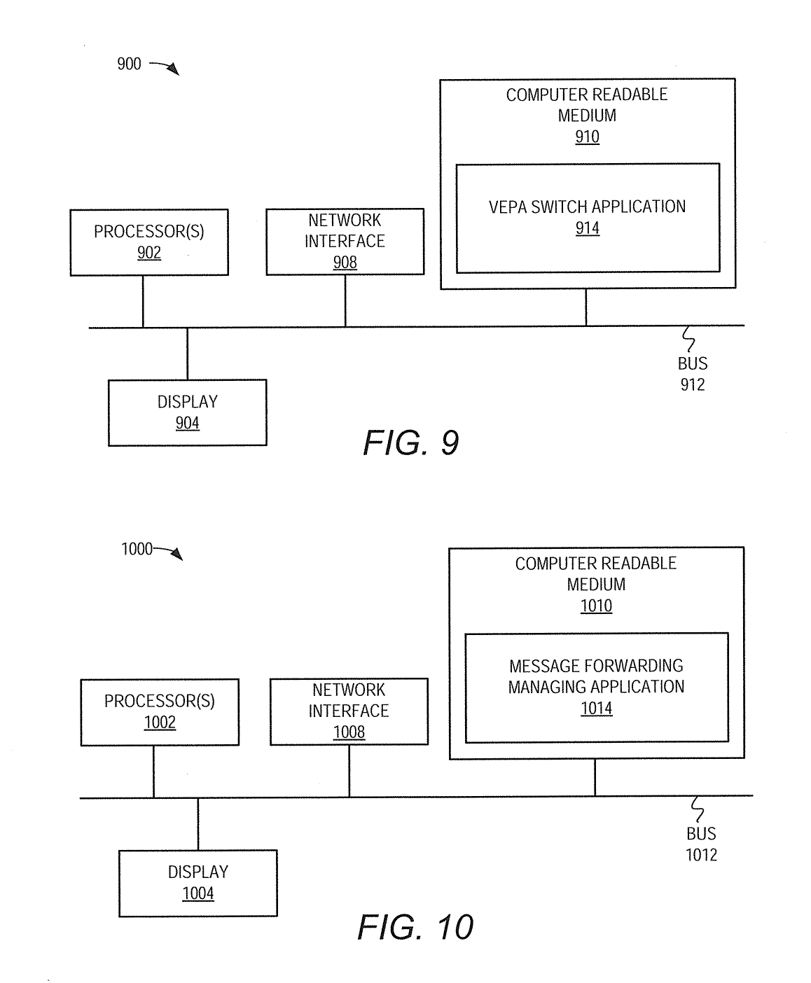

Turning now to FIG. 10, there is shown a schematic representation of a computing device 1000, which may be employed to perform various functions of the SDN controller 120 depicted in FIG. 1, according to an example. The device 1000 may include a processor 1002, a display 1004, such as a monitor; a network interface 1008, such as a Local Area Network LAN, a wireless 802.11x LAN, a 3G mobile WAN or a WiMax WAN; and a computer-readable medium 1010. Each of these components may be operatively coupled to a bus 1012. For example, the bus 1012 may be an EISA, a PCI, a USB, a FireWire, a NuBus, or a PDS.

The computer readable medium 1010 may be any suitable medium that participates in providing instructions to the processor 1002 for execution. For example, the computer readable medium 1010 may be non-volatile media, such as an optical or a magnetic disk; volatile media, such as memory. The computer-readable medium 1010 may also store a message forwarding managing application 1014, which may perform the method 400 depicted in FIG. 4. In this regard, the message forwarding managing application 1014 may include a receiving unit 124, a flow table entry constructing unit 126, and a distributing unit 128.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for forwarding a message by a virtual edge port aggregator (VEPA) switch, said method comprising:
receiving, in the VEPA switch, a message;
determining whether a path forwarding database (Datapath) of the VEPA switch includes a flow table entry for forwarding the message;
in response to a determination that the VEPA switch does not include a flow table entry for forwarding the message,
forwarding the message to a software defined networking (SDN) controller through a SDN protocol that is to construct the flow table entry for forwarding the message according to information contained in the message, the constructed flow table entry identifying an egress port of the VEPA switch for forwarding the message;
obtaining the constructed flow table entry from the SDN controller; and
forwarding the message via the egress port identified in the obtained flow table entry.

2. The method according to claim 1, wherein receiving the message further comprises receiving the message through a downlink port (dvport) of the VEPA switch connected to a virtual network interface controller of a virtual machine (VM) and wherein the SDN controller is to construct the flow table entry to identify the egress port as an uplink port connected to an edge switch.

3. The method according to claim 1, wherein the flow table entry further comprises header fields that include a source media access control (MAC) address and a source port of the message, and wherein determining whether the Datapath includes a flow table entry for forwarding the message further comprises:
determining whether the Datapath includes a flow table entry that has header fields having the source MAC address and the source port of the message;
in response to a determination that the Datapath includes a flow table entry that has header fields having the source MAC address and the source port of the message, determining that the Datapath includes a flow table entry for forwarding the message; and
in response to a determination that the Datapath does not include a flow table entry that has header fields having the source MAC address and the source port of the message, determining that the Datapath does not include a flow table entry for forwarding the message.

4. The method according to claim 1, wherein determining whether the Datapath of the VEPA switch includes a flow table entry for forwarding the message further comprises:
determining whether the message is a unicast message or a multicast message;
in response to a determination that the message is a unicast message, determining whether the Datapath includes a flow table entry that includes the uplink port through which the message was received and the destination MAC address of the message;
in response to a determination that the Datapath includes flow table entries that include the uplink port through which the message was received and the destination MAC address of the message, determining that the Datapath includes a flow table entry for forwarding the message;
in response to a determination that the Datapath does not include a flow table entry that includes the uplink port through which the message was received and the destination MAC address of the message, determining that the Datapath does not include a flow table entry for forwarding the message;
in response to a determination that the message is a multicast message, determining whether the Datapath includes a flow table entry that includes the uplink port through which the message was received and the source MAC address and the destination MAC addresses of the message;
in response to a determination that the Datapath of the data forwarding plane includes flow table entries that include the uplink port through which the message was received and the source MAC address and the destination MAC address of the message, determining that the Datapath includes a plurality of flow table entries for forwarding the message; and
in response to a determination the Datapath of the data forwarding plane does not include a flow table entry that includes the uplink port through which the message was received and the source MAC address and the destination MAC address of the message, determining that the Datapath does not include a flow table entry for forwarding the message.

5. A method for managing message forwarding, said method comprising:
receiving, by a software defined networking (SDN) controller, a message forwarded by a virtual edge port aggregator (VEPA) switch that supports SDN;
constructing, by the SDN controller, a flow table entry for forwarding of the message by the VEPA switch according to information contained in the message, the flow table entry identifying an egress port of the VEPA switch for forwarding the message; and
forwarding the constructed flow table entry to the VEPA switch.

6. The method according to claim 5, wherein constructing the flow table entry further comprises constructing the flow table entry to identify the egress port as an uplink port of the VEPA switch that is connected to an edge switch in response to receipt of the message by the VEPA switch through a downlink interface (dvport) of the VEPA switch connected to a virtual network interface controller on a virtual machine (VM).

7. The method according to claim 5, wherein constructing the flow table entry further comprises constructing the flow table entry to identify the egress port as a downlink interface (dvport) of the VEPA switch that is connected to a virtual network interface controller on a virtual machine (VM) in response to receipt by the VEPA switch of the message through an uplink port connected to an edge switch.

8. The method according to claim 7, wherein constructing the flow table entry to identify the egress port as the dvport of the VEPA switch further comprises:
determining whether the message is a unicast message having a destination media access control (MAC) address that is the MAC address of the virtual machine (VM) connected to the VEPA switch;
in response to a determination that the message is a unicast message having a destination MAC address that is the MAC address of the virtual machine (VM) connected to the VEPA switch, constructing the flow table entry to identify the egress port for forwarding the message to be the dvport of the VEPA switch that is connected to the virtual network interface controller of the VM having the destination MAC address;
in response to a determination that the message is not a unicast message having a destination MAC address that is the MAC address of the virtual machine (VM) connected to the VEPA switch, constructing a plurality of flow table entries to identify a plurality of egress ports to be a plurality of dvports of the VEPA switch that are in a broadcast domain of the VEPA switch except for the dvport port that is connected to the virtual network interface controller of the VM having the source MAC address; and
in response to determination that the message is a multicast message or a broadcast message having a source MAC address that differs from the MAC address of the VM connected to the VEPA switch, constructing a plurality of flow table entries to identify the plurality of egress ports to be a plurality of dvports of the VEPA switch that are in the broadcast domain of the VEPA switch.

9. The method according to claim 5, wherein the flow table entry further includes header fields, the method further comprising:
in response to a determination that the message is a unicast message having a source media access control (MAC) address and destination MAC address that are the MAC addresses of two different virtual machines (VMs) connected to the VEPA switch through dvports, constructing the flow table entry to identify the header fields to include the source MAC address and source port of the message, wherein the source port is the virtual network interface controller through which the VM having the source MAC address sends the message;
in response to a determination that the message is a unicast message having a source MAC address and destination MAC address that are the MAC addresses of two different VMs connected to the VEPA switch and is received by the VEPA through an uplink port, constructing the flow table entry to identify the header fields to include the uplink port through which the message was received and the destination MAC address of the message;
in response to a determination that the message is a multicast message that is received by the VEPA switch through the uplink port, constructing a plurality of flow table entries to identify the header fields to include the uplink port through which the message was received and the source MAC address and the destination MAC addresses of the message.

10. The method according to claim 5, further comprising:
prior to constructing the flow table entry, determining whether the message is a unicast message that the VEPA switch received through an uplink port that is connected to an edge switch and that has a source media access control (MAC) address and a destination MAC address that are not the MAC address of a virtual machine (VM) connected to the VEPA switch;
in response to a determination that the message is a unicast message that the VEPA switch received through an uplink port that is connected to an edge switch and that has a source MAC address and a destination MAC address that are not the MAC address of a virtual machine (VM) connected to the VEPA switch, broadcasting the message in a broadcast domain in which the SDN controller is located; and
in response to a determination that the message is not at least one of a unicast message that the VEPA switch received through an uplink port that is connected to an edge switch and that has a source MAC address and a destination MAC address that are not the MAC address of a virtual machine (VM) connected to the VEPA switch, constructing the flow table entry for forwarding the message according to information contained in the message.

11. A virtual edge port aggregator (VEPA) switch comprising:
a receiving unit to receive a message;
a determining unit to determine whether a path forwarding database (Datapath) of the VEPA switch includes a flow table entry for forwarding the message;
a forwarding unit to forward forwarding the message to a software defined networking (SDN) controller through a SDN protocol, wherein the SDN controller is to construct the flow table entry for forwarding the message according to information contained in the message, the constructed flow table entry identifying an egress port for forwarding the message; and
a processor to implement the receiving unit, the determining unit, and the forwarding unit.

12. The VEPA switch according to claim 11, wherein the flow table entry further comprises header fields that include a source media access control (MAC) address and a source port of the message, and wherein the determining unit is to determine whether the Datapath includes a flow table entry for forwarding the message through:
a determination as to whether the Datapath includes a flow table entry that has header fields having the source MAC address and the source port of the message;
in response to a determination that the Datapath includes a flow table entry that has header fields having the source MAC address and the source port of the message, the determining unit is to determine that the Datapath includes a flow table entry for forwarding the message; and
in response to a determination that the Datapath does not include a flow table entry that has header fields having the source MAC address and the source port of the message, the determining unit is to determine that the Datapath does not include a flow table entry for forwarding the message.

13. The VEPA switch according to claim 12, wherein the determining unit is to determine whether the Datapath of the VEPA switch includes a flow table entry for forwarding the message through:
a determination as to whether the message is a unicast message or a multicast message;
in response to a determination that the message is a unicast message, the determining unit is to determine whether the Datapath includes a flow table entry that includes the uplink port through which the message was received and the destination MAC address of the message;
in response to a determination that the Datapath includes flow table entries that include the uplink port through which the message was received and the destination MAC address of the message, the determining unit is to determine that the Datapath includes a flow table entry for forwarding the message;
in response to a determination that the Datapath does not include a flow table entry that includes the uplink port through which the message was received and the destination MAC address of the message, the determining unit is to determine that the Datapath does not include a flow table entry for forwarding the message;
in response to a determination that the message is a multicast message, the determining unit is to determine whether the Datapath includes a flow table entry that includes the uplink port through which the message was received and the source MAC address and the destination MAC addresses of the message;
in response to a determination that the Datapath of the data forwarding plane includes flow table entries that include the uplink port through which the message was received and the source MAC address and the destination MAC address of the message, the determining unit is to determine that the Datapath includes a plurality of flow table entries for forwarding the message; and
in response to a determination the Datapath of the data forwarding plane does not include a flow table entry that includes the uplink port through which the message was received and the source MAC address and the destination MAC address of the message, the determining unit is to determine that the Datapath does not include a flow table entry for forwarding the message.

14. A software defined networking (SDN) controller comprising:
a receiving unit to receive a message from a virtual edge port aggregator (VEPA) switch that supports SDN;
a flow table entry constructing unit to construct a flow table entry for forwarding of the message by the VEPA switch, wherein the flow table constructing unit is to construct the flow table entry according to information contained in the message and to identify an egress port of the VEPA switch for forwarding the message;
a distributing unit to distribute the constructed flow table entry to the VEPA switch; and
a processor to implement the receiving unit, the flow table entry constructing unit, and the distributing unit.

15. The SDN controller according to claim 14, wherein the flow table entry constructing unit is to construct the flow table entry to identify the egress port of the VEPA switch as an uplink port of the VEPA switch that is connected to an edge switch in response to receipt of the message by the VEPA switch through a downlink interface (dvport) of the VEPA switch connected to a virtual network interface controller on a virtual machine (VM) and wherein the flow table entry constructing unit is to construct the flow table entry to identify the egress port of the VEPA switch as a downlink interface (dvport) of the VEPA switch that is connected to a virtual network interface controller on a virtual machine (VM) in response to receipt by the VEPA switch of the message through an uplink port connected to an edge switch.
